(19) United States
(12) Patent Application Publication
(10) Pub. No.: US 2026/0369215 A1
(43) Pub. Date: Nov. 19, 2026

(54) PIXEL CIRCUIT, DISPLAY DEVICE INCLUDING THE PIXEL CIRCUIT AND ELECTRONIC DEVICE INCLUDING THE DISPLAY DEVICE

(71) Applicant: SAMSUNG DISPLAY CO., LTD., YONGIN-SI (KR)

(72) Inventors: Eseudeo Yun, Yongin-si (KR); NACKHYEON KEUM, Seoul (KR); JEONGHUN BANG, Yongin-si (KR)

(21) Appl. No.: 19/388,107

(22) Filed: Nov. 13, 2025

(30) Foreign Application Priority Data
May 15, 2025 (KR) 10-2025-0063040

(51) Int. Cl. G09G 3/32

(52) U.S. Cl. CPC G09G 3/32; G09G 2300/0819; G09G 2300/0876; G09G 2310/08; G09G 2320/0233; G09G 2320/045; G09G 2330/021

(57) ABSTRACT

A pixel circuit may include a first transistor including a control electrode connected to a first node, a first electrode configured to receive a first power supply voltage, and a second electrode connected to a second node, a second transistor including a control electrode configured to receive a writing gate signal, a first electrode configured to receive a data voltage, and a second electrode connected to the first node, a third transistor including a control electrode configured to receive a first emission signal, a first electrode connected to the second node, a second electrode connected to a third node, a first capacitor including a first electrode connected to the first node and a second electrode connected to the third node, a second capacitor including a first electrode connected to the second node and a second electrode configured to receive the first emission signal, and a light emitting element.

### CROSS-REFERENCE TO RELATED APPLICATIONS

This U.S. patent application claims priority under 35 U.S.C. § 119 to Korean Patent Application No. 10-2025-0063040, filed on May 15, 2025 in the Korean Intellectual Property Office KIPO, the disclosure of which is incorporated by reference in its entirety herein.

### 1. TECHNICAL FIELD

Embodiments of the present inventive concept relate to a pixel circuit, a display device including the pixel circuit, and an electronic device including the display device.

### 2. DISCUSSION OF RELATED ART

A display device may include a display panel, a gate driver, a data driver, an emission driver, and a driving controller. A pixel circuit may be provided for each pixel row of the display panel.

In some driving methods, gate signals of adjacent pixel rows may overlap to improve resolution. However, such overlap can undesirably influence the operation of pixel circuits, leading to variations in driving current

These variations may appear as luminance differences, such as visible lines, which degrade perceived display quality.

### SUMMARY

At least one embodiment of the present disclosure provides a pixel circuit that enhances display quality of a display device, a display device including the pixel circuit and an electronic device including the display device.

According to an embodiment, a pixel circuit includes a first transistor including a control electrode connected to a first node, a first electrode configured to receive a first power supply voltage, and a second electrode connected to a second node, a second transistor including a control electrode configured to receive a writing gate signal, a first electrode configured to receive a data voltage, and a second electrode connected to the first node, a third transistor including a control electrode configured to receive a first emission signal, a first electrode connected to the second node, a second electrode connected to a third node, a first capacitor including a first electrode connected to the first node and a second electrode connected to the third node, a second capacitor including a first electrode connected to the second node and a second electrode configured to receive the first emission signal, and a light emitting element connected to receive a second power supply voltage.

In an embodiment, the second capacitor is configured to change a voltage of the second node in response to a change in a level of the first emission signal.

In an embodiment, the second capacitor is configured to increase a voltage of the second node in response to the level of the first emission signal increasing from a low level to a high level.

In an embodiment, the first transistor is configured to turn off when the voltage of the second node is increased to the high level.

In an embodiment, the second capacitor is configured to decrease a voltage of the second node in response to the level of the first emission signal decreasing from a high level to a low level.

In an embodiment, the pixel circuit may further include a fourth transistor including a control electrode configured to receive an anode initialization gate signal, a first electrode configured to receive an anode initialization voltage, and a second electrode connected to the anode electrode of the light emitting element.

In an embodiment, the pixel circuit may further include a fifth transistor including a control electrode configured to receive an initialization gate signal, a first electrode configured to receive a reference voltage, and a second electrode connected to the first node.

In an embodiment, the pixel circuit may further include a third capacitor including a first electrode configured to receive the first power supply voltage and a second electrode connected to the third node.

In an embodiment, the first transistor may further include a second control electrode connected to the third node.

In an embodiment, the pixel circuit may further include a sixth transistor including a control electrode configured to receive a second emission signal, a first electrode connected to the third node, and a second electrode connected to the anode electrode of the light emitting element.

According to an embodiment, a display device includes a display panel including a pixel circuit and a display panel driver configured to drive the display panel. The pixel circuit includes a first transistor including a control electrode connected to a first node, a first electrode configured to receive a first power supply voltage, and a second electrode connected to a second node, a second transistor including a control electrode configured to receive a writing gate signal, a first electrode configured to receive a data voltage, and a second electrode connected to the first node, a third transistor including a control electrode configured to receive a first emission signal, a first electrode connected to the second node, a second electrode connected to a third node, a first capacitor including a first electrode connected to the first node and a second electrode connected to the third node, a second capacitor including a first electrode connected to the second node and a second electrode configured to receive the first emission signal, and a light emitting element connected to receive a second power supply voltage.

In an embodiment, the second capacitor is configured to change a voltage of the second node in response to a change in a level of the first emission signal.

In an embodiment, the second capacitor is configured to increase a voltage of the second node in response to the first emission signal increasing from a low level to a high level.

In an embodiment, the first transistor is configured to turn off when the voltage of the second node is increased to the high level.

In an embodiment, the second capacitor is configured to decrease a voltage of the second node in response to the level of the first emission signal decreasing from a high level to a low level.

According to an embodiment, an electronic device includes a processor configured to generate an input control signal and input image data, a display panel including a pixel circuit, and a display panel driver configured to drive the display panel based on the input control signal and the input image data. The pixel circuit includes a first transistor including a control electrode connected to a first node, a first electrode configured to receive a first power supply voltage, and a second electrode connected to a second node, a second transistor including a control electrode configured to receive a writing gate signal, a first electrode configured to receive a data voltage, and a second electrode connected to the first node, a third transistor including a control electrode configured to receive a first emission signal, a first electrode connected to the second node, a second electrode connected to a third node, a first capacitor including a first electrode connected to the first node and a second electrode connected to the third node, a second capacitor including a first electrode connected to the second node and a second electrode configured to receive the first emission signal, and a light emitting element connected to receive a second power supply voltage.

In an embodiment, the second capacitor is configured to change a voltage of the second node in response to a change in a level of the first emission signal.

In an embodiment, the second capacitor is configured to increase a voltage of the second node in response to the level of the first emission signal increasing from a low level to a high level.

In an embodiment, the first transistor is configured to turn off when the voltage of the second node is increased to the high level.

In an embodiment, the second capacitor is configured to decrease a voltage of the second node in response to the level of the first emission signal decreasing from a high level to a low level.

Therefore, the pixel circuit according to embodiments of the present inventive concept may include a first transistor including a control electrode connected to a first node, a first electrode connected to receive a first supply voltage, and a second electrode connected to a second node, a second transistor including a control electrode connected to receive a writing gate signal, a first electrode connected to receive a data voltage, and a second electrode connected to the first node, a third transistor including a control electrode connected to receive a first emission signal, a first electrode connected to the second node, and a second electrode connected to a third node, a first capacitor including a first electrode connected to the first node and a second electrode connected to the third node, a second capacitor including a first electrode connected to the second node and a second electrode connected to receive the first emission signal, and a light emitting element connected to receive a second power supply voltage.

When the pixel circuit includes the second capacitor, the voltage of the second node may be increased by a coupling operation of the second capacitor during a data writing period. When the voltage of the second node is increased in the data writing period, a difference between a voltage of the first node and a voltage of the second node may be less than a threshold voltage of the first transistor regardless of the voltage of the first node. For example, during the data writing period, the first transistor may be turned off regardless of the voltage of the first node. When the first transistor is turned off during the data writing period, the voltage of the second node should not change according to the voltage of the first node. When the voltage of the second node is not changed according to the voltage of the first node, the pixel circuit may emit light at a target luminance corresponding to the data voltage and display quality of the display device may be enhanced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to an embodiment of the present inventive concept.

FIG. 2 is a circuit diagram illustrating an embodiment of a pixel circuit included in a display panel included in the display device of FIG. 1.

FIG. 3 is a timing diagram illustrating an operation of the pixel circuit of FIG. 2.

FIG. 4 is a circuit diagram illustrating an operation of the pixel circuit of FIG. 2 in a first period of the timing diagram of FIG. 3.

FIG. 5 is a circuit diagram illustrating an operation of the pixel circuit of FIG. 2 in a second period of the timing diagram of FIG. 3.

FIG. 6 is a circuit diagram illustrating an operation of the pixel circuit of FIG. 2 in a third period of the timing diagram of FIG. 3.

FIG. 7 is a circuit diagram illustrating an operation of the pixel circuit of FIG. 2 in a fourth period of the timing diagram of FIG. 3.

FIG. 8 is a graph illustrating a voltage of a second node included in the pixel circuit of FIG. 2 in the third period of the timing diagram of FIG. 3.

FIGS. 9A and 9B are tables illustrating an embodiment of a luminance difference according to a capacitance of a second capacitor of the pixel circuit of FIG. 2 included in an n-th pixel row in a first case in which a gray-level of an (n-1)-th pixel row is a maximum gray-level.

FIGS. 10A and 10B are tables illustrating an embodiment of a luminance difference according to the capacitance of the second capacitor of the pixel circuit of FIG. 2 included in the n-th pixel row in a second case in which a gray-level of the (n-1)-th pixel row is a minimum gray-level.

FIG. 11 is a block diagram illustrating an electronic device according to an embodiment of the present inventive concept.

FIG. 12 is a diagram illustrating an embodiment in which the electronic device of FIG. 11 is implemented as a smart phone.

### DETAILED DESCRIPTION OF EMBODIMENTS

A display device may include a display panel and a gate driver. The gate driver may output a gate signal to each pixel row of the display panel to select a pixel circuit of a corresponding pixel row. When a gate signal is at an activation level, pixel circuits of the selected row may receive a data voltage through a data line during a data writing period. As the resolution of the display device increases, a duration in which the gate signal remains at an activation level may not be reduced to less than one horizontal period. Accordingly, the gate driver may be driven in an overlap driving method in which the gate signals for adjacent pixel rows are overlapped and applied. The gate signals may be overlapped for the pixel rows, so that when the pixel circuit of a previous pixel row and the pixel circuit of next pixel row are connected to the same data line during a data writing period, a data voltage corresponding to a gray-level of the previous pixel row may be simultaneously transmitted to the pixel circuit of the previous pixel row and the pixel circuit of the next pixel row. In the data writing period, a driving transistor included in the pixel circuit of the next pixel row may be turned on by the data voltage corresponding to the gray-level of the prior pixel row. Accordingly, an electrical state of the driving transistor included in the pixel circuit of the next row may be unintentionally changed. Because the data voltage of the previous pixel row can influence the driving transistor of the next pixel row, a voltage difference that determines a driving current of the driving transistor may be altered. As a result, the pixel circuit of the next row may not emit light accurately at a target luminance.

For example, it is assumed that the gray-level of the previous pixel row is a maximum gray-level and a gray-level of the next pixel row is lower than the maximum gray-level. During the data writing period of the previous pixel row, the data voltage of the previous pixel row may affect the driving transistor of the next pixel row, causing its electrical state to change. As a result, the driving current of the next pixel row may be reduced, and the pixel circuit of the next pixel row may emit light at a luminance lower than a luminance corresponding to its gray-level, resulting in a visible dark line.

In another example, it is assumed that the gray-level of the previous pixel row is a minimum gray-level and the gray-level of the next pixel row is higher than the minimum gray-level. During the data writing period of the previous pixel row, the data voltage of the previous pixel row may affect the driving transistor of the next n-th pixel row. As a result, the driving current of the next pixel row may be increased, and the pixel circuit of the next pixel row may emit light at a luminance higher than the luminance corresponding to its gray-level, resulting in a visible bright line.

Thus, the pixel circuit may be adjusted to enhance image quality. Hereinafter, embodiments of the pixel circuit, a display device including the pixel circuit, and an electronic device including the display device will be described in more detail with reference to the accompanying drawings. The same reference numerals are used for the same components in the drawings, and redundant descriptions of the same components will be omitted.

The pixel circuit includes multiple transistors, capacitors, and a light emitting element, and further includes a second capacitor configured to couple an emission signal to a node of the driving transistor. During a data writing period, the second capacitor temporarily raises the voltage of the node to turn off the driving transistor regardless of the data voltage applied to its control electrode. By preventing the driving transistor from being affected by data voltages of other pixel rows during overlapping data writes, the pixel circuit allows each pixel to emit light at a target luminance, thereby enhancing the display quality of the display device.

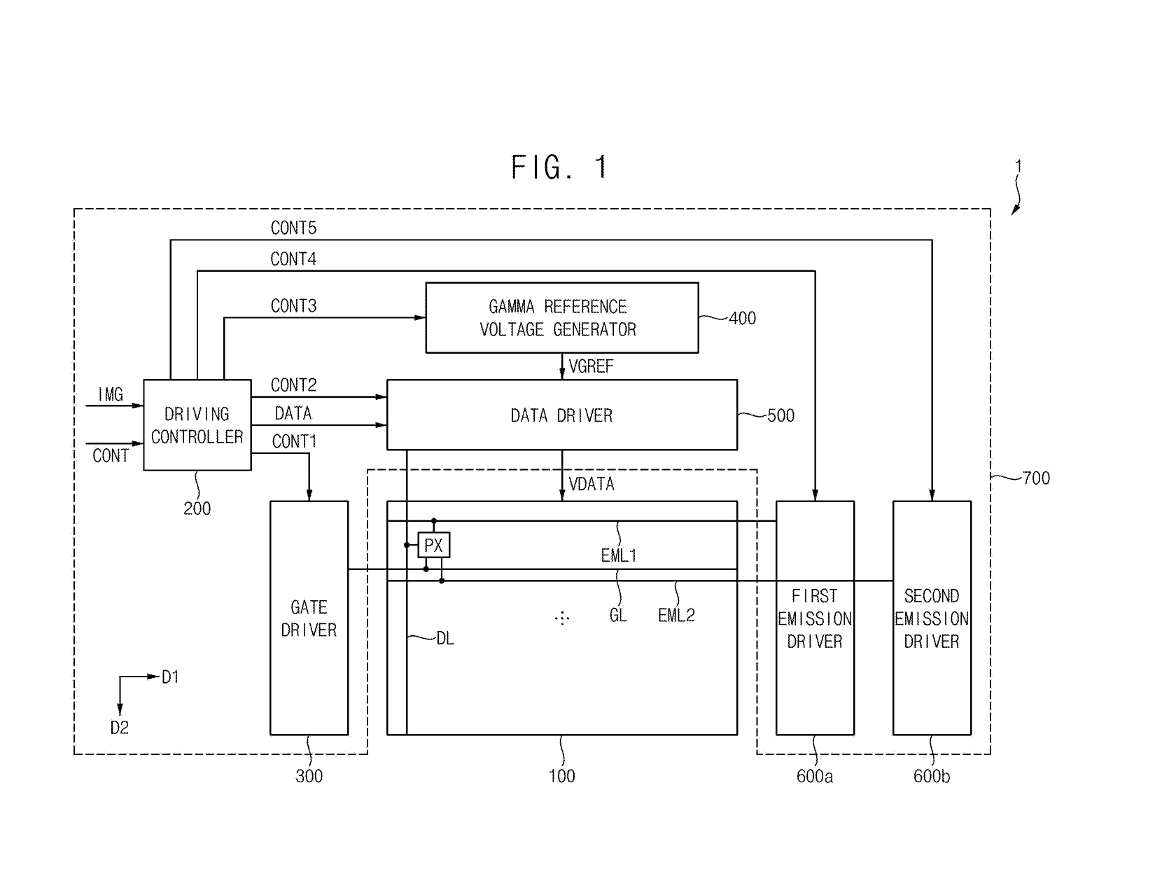

FIG. 1 is a block diagram illustrating a display device 1 according to an embodiment of the present inventive concept.

Referring to FIG. 1, the display device 1 may include a display panel 100 and a display panel driver 700. The display panel driver 700 may include a driving controller 200 (e.g., a controller circuit), a gate driver 300 (e.g., a first driver circuit), a gamma reference voltage generator 400, a data driver 500 (e.g., a second driver circuit), a first emission driver 600a (e.g., a third driver circuit), and a second emission driver 600b (e.g., a fourth driver circuit).

For example, the driving controller 200 and the data driver 500 may be integrated into a single chip. For example, the driving controller 200, the gamma reference voltage generator 400, and the data driver 500 may be integrated into a single chip. A driving module including at least the driving controller 200 and the data driver 500 which are integrated into the single chip may be referred to as a timing controller embedded data driver (TED).

The display panel 100 may include a display region on which an image is displayed and a peripheral region adjacent to or surrounding the display region. For example, the peripheral region may be referred to as a bezel.

The display panel 100 may include gate lines GL, first emission lines EML1, second emission lines EML2, data lines DL, and pixel circuits PX. For example, the gate lines GL may extend in a first direction D1, the first emission lines EML1 may extend in the first direction D1, the second emission lines EML2 may extend in the first direction D1, and the data lines DL may extend in a second direction D2 crossing the first direction D1.

The driving controller 200 may receive input image data IMG and an input control signal CONT from an external device. For example, the input image data IMG may include red image data, green image data, and blue image data. In some embodiments, the input image data IMG may further include white image data. In another example, the input image data IMG may include magenta image data, yellow image data, and cyan image data. The input control signal CONT may include a master clock signal and a data enable signal. The master clock signal may provide a main timing reference for synchronizing operations across the display panel 100. The data enable signal may indicate when valid image data is present on the data lines DL and should be latched by the pixel circuits. The input control signal CONT may further include a vertical synchronizing signal and a horizontal synchronizing signal. The vertical synchronizing signal may indicate the start of a new frame, while the horizontal synchronizing signal may indicate the start of a new row (scan line) within the frame.

The driving controller 200 may generate a gate control signal CONT1, a data control signal CONT2, a gamma control signal CONT3, a first emission control signal CONT4, a second emission control signal CONT5, and a data signal DATA based on the input image data IMG and the input control signal CONT.

The driving controller 200 may generate the gate control signal CONT1 for controlling an operation of the gate driver 300 based on the input control signal CONT, and may output the gate control signal CONT1 to the gate driver 300.

The driving controller 200 may generate the data control signal CONT2 for controlling an operation of the data driver 500 based on the input control signal CONT, and may output the data control signal CONT2 to the data driver 500.

The driving controller 200 may generate the data signal DATA based on the input image data IMG. The driving controller 200 may output the data signal DATA to the data driver 500.

The driving controller 200 may generate the gamma control signal CONT3 for controlling an operation of the gamma reference voltage generator 400 based on the input control signal CONT, and may output the gamma control signal CONT3 to the gamma reference voltage generator 400.

The driving controller 200 may generate the first emission control signal CONT4 for controlling an operation of the first emission driver 600a based on the input control signal CONT, and may output the first emission control signal CONT4 to the first emission driver 600a.

The driving controller 200 may generate the second emission control signal CONT5 for controlling an operation of the second emission driver 600b based on the input control signal CONT, and may output the second emission control signal CONT5 to the second emission driver 600b.

While FIG. 1 illustrates the first emission driver 600a and the second emission driver 600b being disposed on a first side of a display panel 100, the present inventive concept is not limited thereto. For example, the first emission driver 600a and the second emission driver 600b may be disposed on a second side of the display panel 100. For example, the first emission driver 600a may be disposed on the first side of the display panel 100 and the second emission driver 600b may be disposed on the second side of the display panel 100. For example, the first emission driver 600a and the second emission driver 600b may be integrally formed.

The gate driver 300 may generate gate signals transmitted to the pixel circuits PX through the gate lines GL in response to the gate control signal CONT1 received from the driving controller 200. The gate driver 300 may output the gate signals to the gate lines GL. For example, the gate driver 300 may be integrated on the peripheral region of the display panel 100.

The gamma reference voltage generator 400 may generate a gamma reference voltage VGREF in response to the gamma control signal CONT3 received from the driving controller 200. The gamma reference voltage generator 400 may output the gamma reference voltage VGREF to the data driver 500. The gamma reference voltage VGREF may be used by the data driver 500 to convert input image data into data voltages having luminance characteristics suitable for the display panel 100.

In an embodiment, the gamma reference voltage generator 400 may be disposed in the driving controller 200, or in the data driver 500.

The data driver 500 may receive the data control signal CONT2 and the data signal DATA from the driving controller 200 and may receive the gamma reference voltages VGREF from the gamma reference voltage generator 400. The data driver 500 may convert the data signal DATA having a digital type into data voltages having an analog type using the gamma reference voltages VGREF. The data driver 500 may output the data voltages to the data lines DL.

The first emission driver 600a may generate first emission signals transmitted to the pixel circuits PX through the first emission lines EML1 in response to the first emission control signal CONT4 received from the driving controller 200. The first emission driver 600a may output the first emission signals to the first emission lines EML1. For example, the first emission driver 600a may be integrated on the peripheral region of the display panel 100.

The second emission driver 600b may generate second emission signals transmitted to the pixel circuits PX through the second emission lines EML2 in response to the second emission control signal CONT5 received from the driving controller 200. The second emission driver 600b may output the second emission signals to the second emission lines EML2. For example, the second emission driver 600b may be integrated on the peripheral region of the display panel 100.

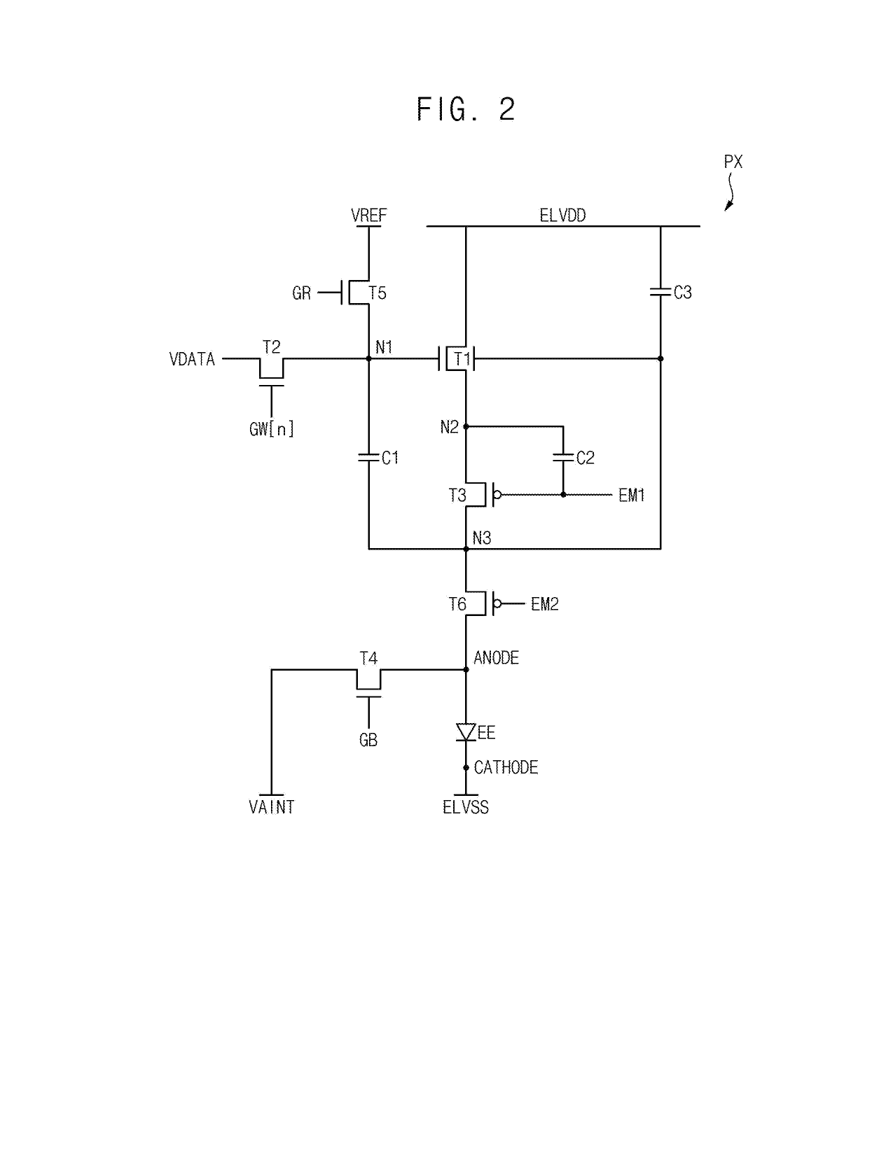

FIG. 2 is a circuit diagram illustrating an embodiment of the pixel circuit PX included in the display panel 100 included in the display device 1 of FIG. 1.

Referring to FIG. 2, the pixel circuit PX may include a first transistor T1, a second transistor T2, a third transistor T3, a first capacitor C1, a second capacitor C2, and a light emitting element EE. In some embodiments, the pixel circuit PX may further include a fourth transistor T4, a fifth transistor T5, a sixth transistor T6, and/or a third capacitor C3.

The display panel 100 may include first to m-th pixel rows, where m is an integer equal to or greater than 1. Each of the first to m-th pixel rows may include the pixel circuit PX. A configuration and an operation of the pixel circuit PX may be identical for each pixel row except that a writing gate signal GW having an activation level is sequentially applied to each pixel row. Accordingly, it will be described with respect to the pixel circuit PX of the n-th pixel row, where n is an integer equal to or greater than 1 and less than or equal to m.

The first transistor T1 may include a control electrode connected to a first node N1, a first electrode which receives a first power supply voltage ELVDD, and a second electrode connected to a second node N2. The first transistor T1 may be referred to as a driving transistor.

The writing gate signal GW applied to the pixel circuit PX of the n-th pixel row may be an n-th writing gate signal GW[n].

The second transistor T2 may include a control electrode which receives the n-th writing gate signal GW[n], a first electrode which receives the data voltage VDATA, and a second electrode connected to the first node N1.

The third transistor T3 may include a control electrode which receives a first emission signal EM1, a first electrode connected to the second node N2, and a second electrode connected to a third node N3.

The first capacitor C1 may include a first electrode connected to the first node N1 and a second electrode connected to the third node N3.

In an embodiment, the second capacitor C2 includes a first electrode connected to the second node N2 and a second electrode which receives the first emission signal EM1. By this configuration, changes in the level of the first emission signal EM1 may be capacitively coupled to the voltage of the second node N2. For example, when the first emission signal EM1 transitions from a low level to a high level during a data writing period, the voltage of the second node N2 may be increased by a coupling operation of the second capacitor C2. As a result, a voltage difference between the first node N1 and the second node N2 may become less than a threshold voltage of the first transistor T1, such that the first transistor T1 remains turned off regardless of the voltage applied to the first node N1. Conversely, when the first emission signal EM1 transitions from a high level to a low level during an emission period, the voltage of the second node N2 may be decreased by the coupling operation of the second capacitor C2, thereby allowing the first transistor T1 to be turned on in accordance with the data voltage stored at the first node N1 and enabling the light emitting element EE to emit light at a target luminance. Accordingly, the inclusion of the second capacitor C2 may stabilize the voltage of the second node N2 against disturbance caused by overlapping gate signals of adjacent pixel rows, may suppress luminance errors such as dark lines and bright lines, and may enhance both the accuracy and the quality of images being displayed. In an embodiment, the second capacitor C2 is directly connected to at least one of a drain electrode of the first transistor T1, a source electrode of the third transistor T3, or a gate electrode of the third transistor T3. In an embodiment, a resistor may be present between at least one of the second node N2 and the second capacitor C2, or between the second capacitor C2 and the gate electrode of the third transistor T3.

The light emitting element EE may include an anode electrode ANODE and a cathode electrode CATHODE which receives a second power supply voltage ELVSS. The first power supply voltage ELVDD may provide power to the light emitting element EE. The second power supply voltage ELVSS may be a voltage less than the first power supply voltage ELVDD, such as ground voltage or a negative voltage. The light emitting element EE may receive current based on the voltage difference between the first power supply voltage ELVDD and the second power supply voltage ELVSS, as controlled by the driving transistor T1.

The fourth transistor T4 may include a control electrode which receives an anode initialization gate signal GB, a first electrode which receives an anode initialization voltage VAINT, and a second electrode connected to the anode electrode ANODE of the light emitting element EE.

The fifth transistor T5 may include a control electrode which receives an initialization gate signal GR, a first electrode which receives a reference voltage VREF, and a second electrode connected to the first node N1.

The sixth transistor T6 may include a control electrode which receives a second emission signal EM2, a first electrode connected to the third node N3, and a second electrode connected to the anode electrode ANODE of the light emitting element EE.

The third capacitor C3 may include a first electrode which receives the first power supply voltage ELVDD and a second electrode connected to the third node N3.

The first transistor T1 may further include a second control electrode (e.g. a back-gate electrode) connected to the third node N3 which is the second electrode of the third capacitor C3. A voltage of the third node N3 is applied to the second control electrode of the first transistor T1, so that a shift in a threshold voltage of the first transistor T1 due to stress may be prevented. Accordingly, stability and reliability of the pixel circuit PX may be enhanced.

In an embodiment, each of the first transistor T1, the second transistor T2, the fourth transistor T4, and the fifth transistor T5 may be implemented as an N-type transistor. Each of the third transistor T3 and the sixth transistor T6 may be implemented as a P-type transistor.

Each of the first transistor T1, the second transistor T2, the fourth transistor T4, and the fifth transistor T5 may be implemented as the N-type transistor, so that a leakage current of each of the first transistor T1, the second transistor T2, the fourth transistor T4, and the fifth transistor T5 may be decreased. Accordingly, power consumption of the display device 1 may be reduced.

In addition, each of the third transistor T3 and the sixth transistor T6 may be implemented as the P-type transistor, so that mobility of each of the third transistor T3 and the sixth transistor T6 may be enhanced. Accordingly, when the third transistor T3 and the sixth transistor T6 are turned on, loss of a driving current flowing through the third transistor T3 and the sixth transistor T6 may be decreased. For example, the light emitting element EE may emit light at a target luminance and display quality of the display device 1 may be enhanced.

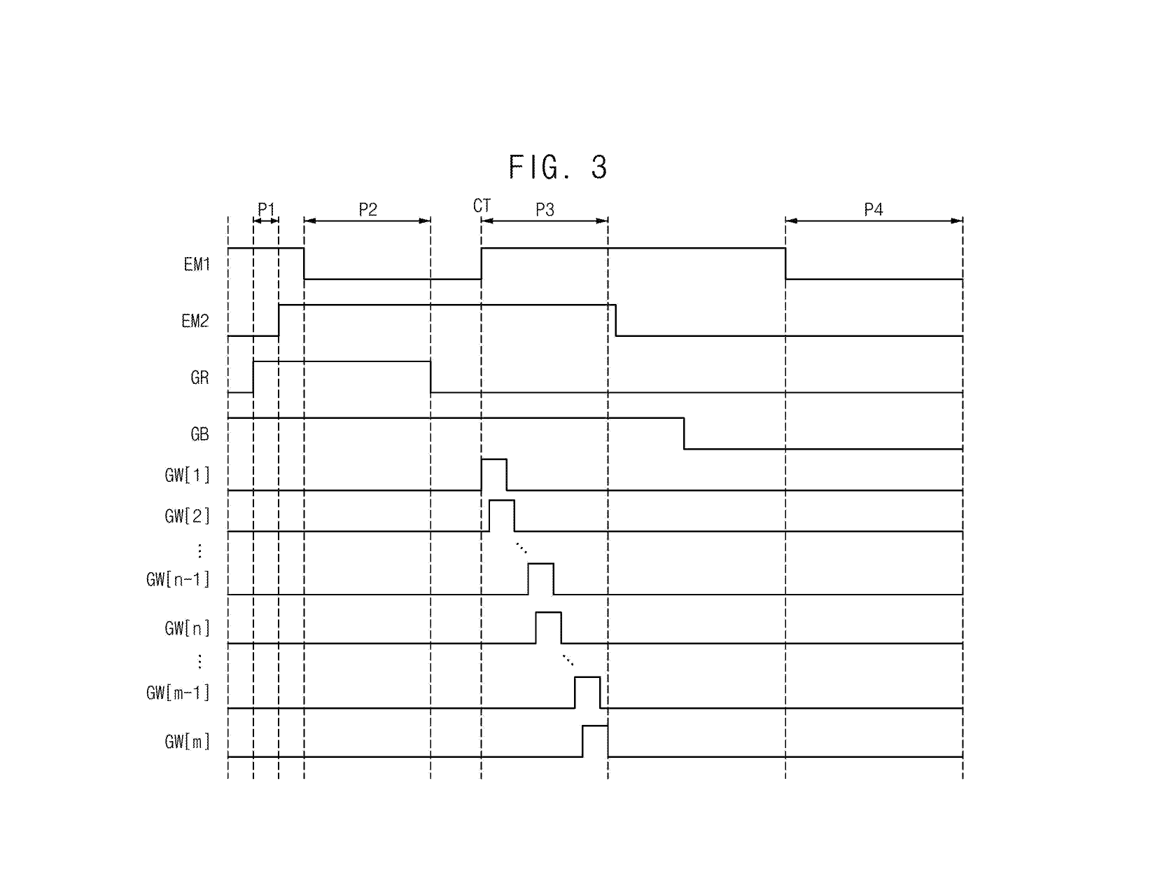

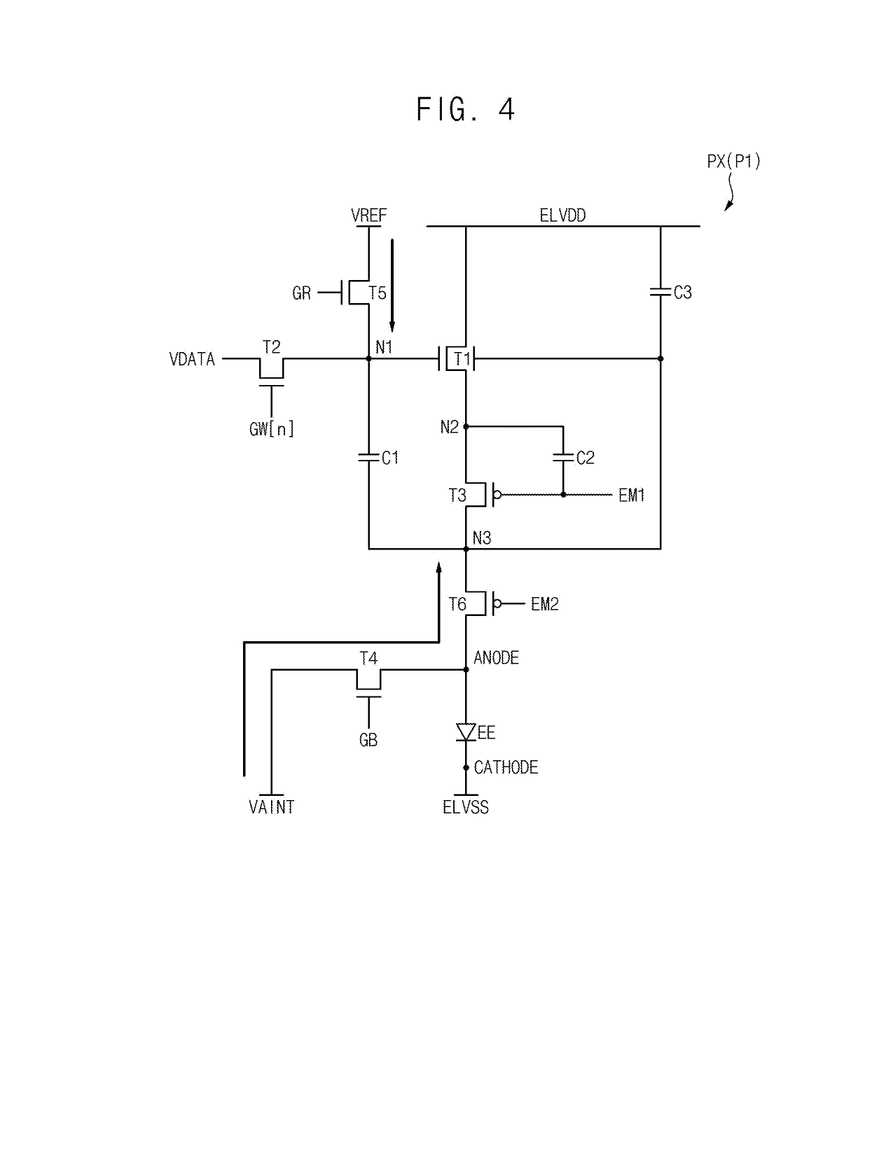

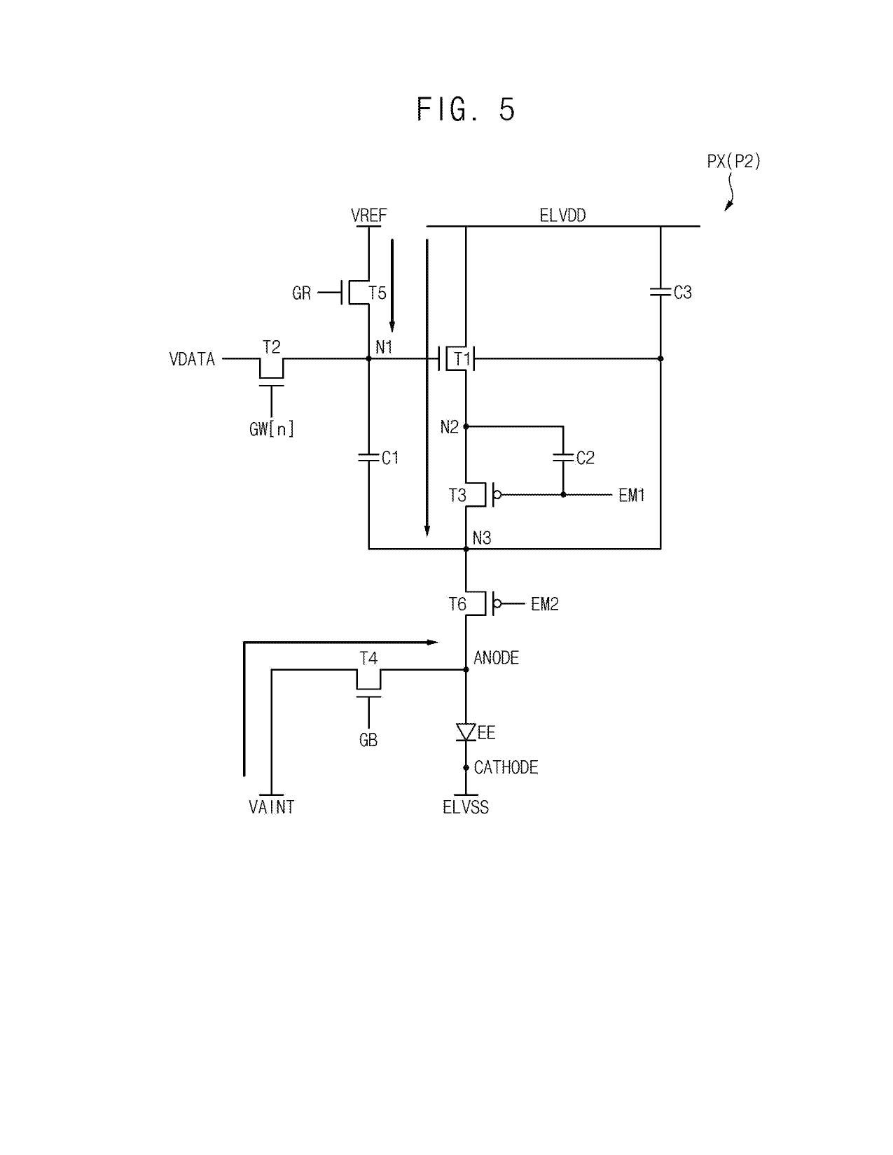

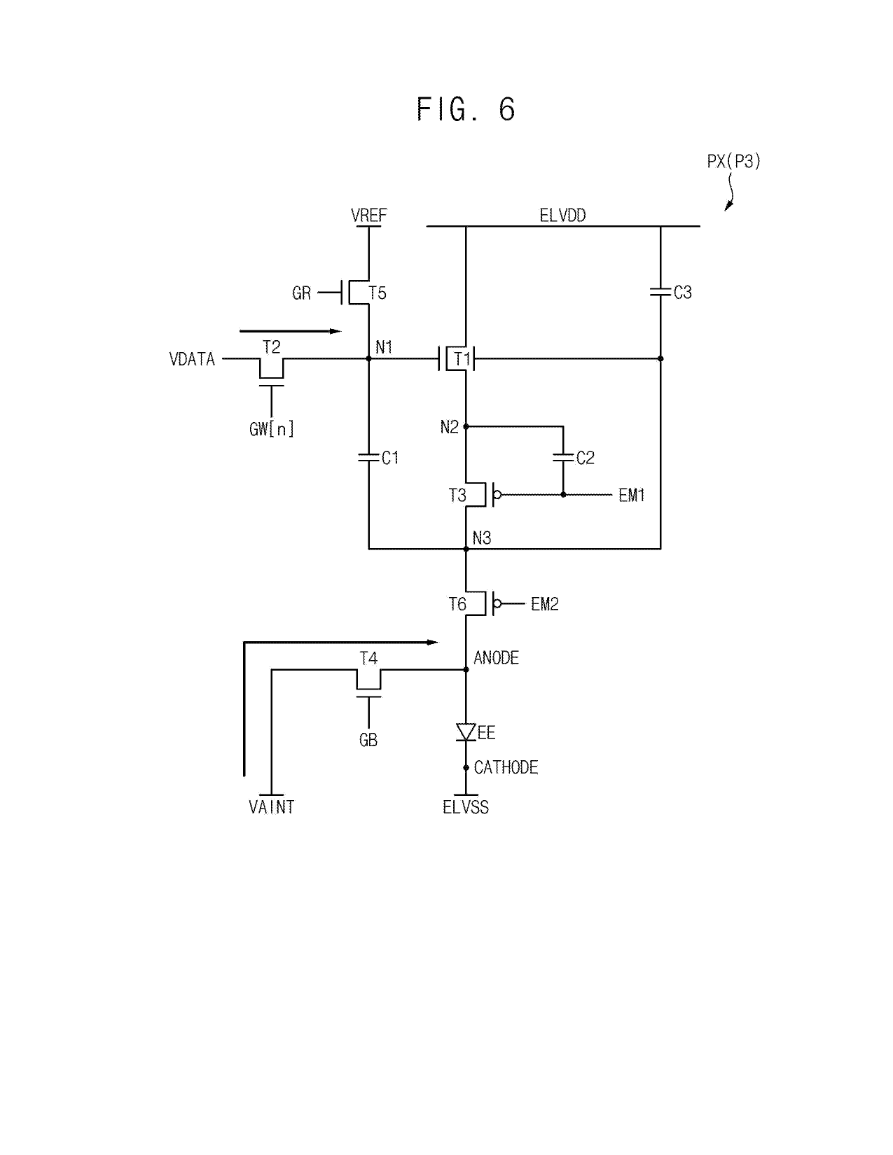

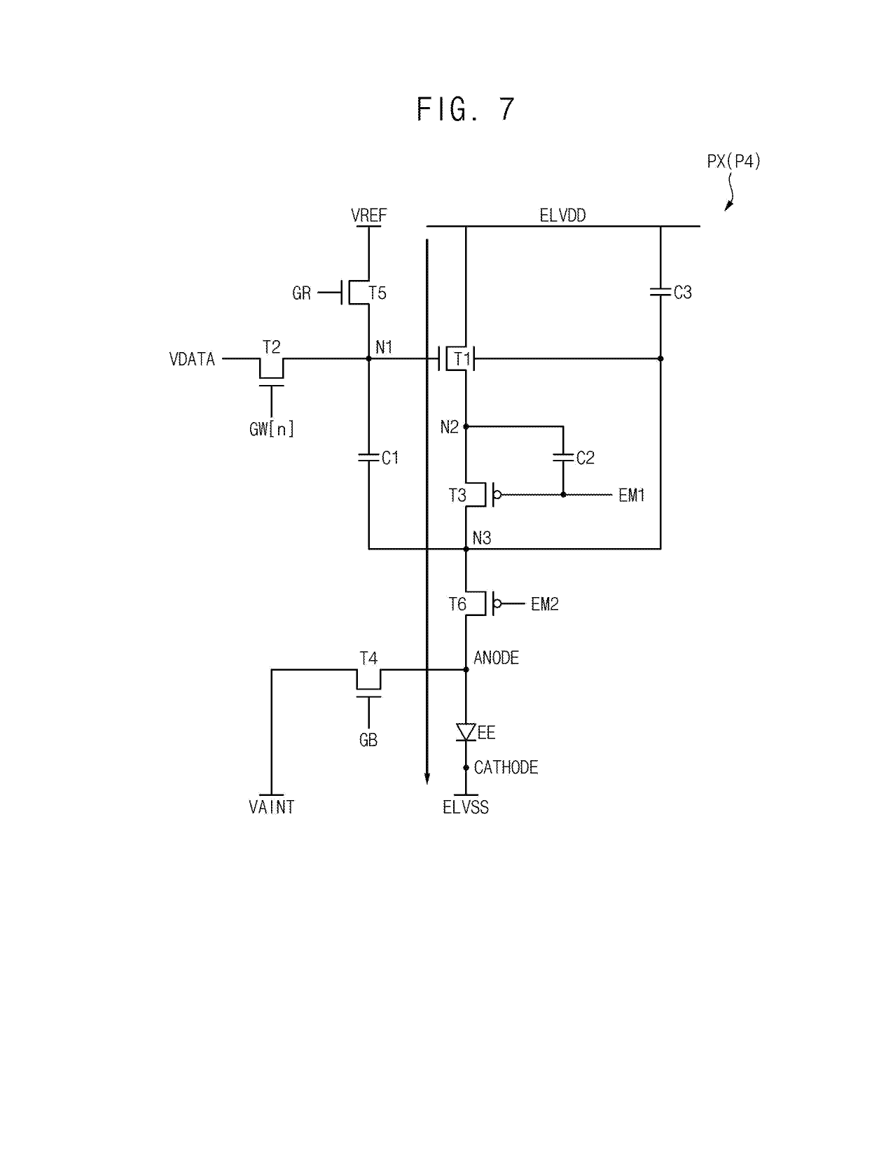

FIG. 3 is a timing diagram illustrating an operation of the pixel circuit PX of FIG. 2. FIG. 4 is a circuit diagram illustrating an operation of the pixel circuit PX of FIG. 2 in a first period P1 of the timing diagram of FIG. 3. FIG. 5 is a circuit diagram illustrating an operation of the pixel circuit PX of FIG. 2 in a second period P2 of the timing diagram of FIG. 3. FIG. 6 is a circuit diagram illustrating an operation of the pixel circuit PX of FIG. 2 in a third period P3 of the timing diagram of FIG. 3. FIG. 7 is a circuit diagram illustrating an operation of the pixel circuit PX of FIG. 2 in a fourth period P4 of the timing diagram of FIG. 3.

For example, the first writing gate signal GW[1] may be applied to the pixel circuit PX included in the first pixel row and the second writing gate signal GW[2] may be applied to the pixel circuit PX included in the second pixel row. In this way, the (n-1)-th writing gate signal GW[n-1] may be applied to the pixel circuit PX included in the (n-1)-th pixel row and the n-th writing gate signal GW[n] may be applied to the pixel circuit PX included in the n-th pixel row. In this way, the (m-1)-th writing gate signal GW[m-1] may be applied to the pixel circuit PX included in the (m-1)-th pixel row and the m-th writing gate signal GW[m] may be applied to the pixel circuit PX included in the m-th pixel row.

Referring to FIGS. 3-7, periods in which the pixel circuit PX operates may include the first period P1, the second period P2, the third period P3, and the fourth period P4.

The first period P1 may be referred to as a first initialization period. In the first period P1, the first emission signal EM1 may have a deactivation level and the second emission signal EM2 may have an activation level. For example, the first emission signal EM1 may have a high level and the second emission signal EM2 may have a low level. The initialization gate signal GR may have an activation level and the anode initialization gate signal GB may have an activation level. For example, the initialization gate signal GR may have the high level and the anode initialization gate signal GB may have the high level. In addition, the first to m-th writing gate signals GW[1] to GW[m] may have the deactivation level. For example, the first to m-th writing gate signals GW[1] to GW[m] may have the low level.

As described in FIG. 4, the second transistor T2 may be turned off in response to the n-th writing gate signal GW[n] having the deactivation level and the third transistor T3 may be turned off in response to the first emission signal EM1 having the deactivation level. The fourth transistor T4 may be turned on in response to the anode initialization gate signal GB having the activation level and the fifth transistor T5 may be turned on in response to the initialization gate signal GR having the activation level. In addition, the sixth transistor T6 may be turned on in response to the second emission signal EM2 having the activation level.

When the fourth transistor T4 is turned on, the anode initialization voltage VAINT may be transmitted to the anode electrode ANODE of the light emitting element EE, thereby initializing the anode electrode ANODE of the light emitting element EE to the anode initialization voltage VAINT.

The sixth transistor T6, which is turned on, may transmit a voltage of the anode electrode ANODE of the light emitting element EE to the third node N3. For example, when the sixth transistor T6 is turned on, the anode initialization voltage VAINT may be transmitted to the third node N3, thereby initializing the third node N3 to the anode initialization voltage VAINT.

When the fifth transistor T5 is turned on, the reference voltage VREF may be transmitted to the first node N1, thereby initializing the first node N1 to the reference voltage VREF.

The second period P2 may be referred to as a threshold voltage compensation period. In the second period P2, the first emission signal EM1 may have an activation level and the second emission signal EM2 may have a deactivation level. For example, the first emission signal EM1 may have the low level and the second emission signal EM2 may have the high level. The initialization gate signal GR may have the activation level and the anode initialization gate signal GB may have the activation level. For example, the initialization gate signal GR may have the high level and the anode initialization gate signal GB may have the high level. In addition, the first to m-th writing gate signals GW[1] to GW[m] may have the deactivation level. For example, the first to m-th writing gate signals GW[1] to GW[m] may have the low level.

As described in FIG. 5, the second transistor T2 may be turned off in response to the n-th writing gate signal GW[n] having the deactivation level and the third transistor T3 may be turned on in response to the first emission signal EM1 having the activation level. The fourth transistor T4 may be turned on in response to the anode initialization gate signal GB having the activation level and the fifth transistor T5 may be turned on in response to the initialization gate signal GR having the activation level. In addition, the sixth transistor T6 may be turned off in response to the second emission signal EM2 having the deactivation level.

When the third transistor T3 is turned on, the voltage of the third node N3 may be transmitted to the second node N2, thereby initializing the second node N2 to the anode initialization voltage VAINT. A difference between a voltage of the first node N1 and a voltage of the second node N2 may be greater than the threshold voltage of the first transistor T1. When the difference between the voltage of the first node N1 and the voltage of the second node N2 is greater than the threshold voltage of the first transistor T1, the threshold voltage of the first transistor T1 may be compensated. The threshold voltage of the first transistor T1 may be compensated, so that the voltage VN2 of the second node N2 satisfies “VN2 = VREF − Vth1”, where VN2 denotes the voltage of the second node N2, VREF denotes a reference voltage VREF, and Vth1 denotes the threshold voltage of the first transistor T1.

The third period P3 may be referred to as a data writing period. In the third period P3, the first emission signal EM1 may have the deactivation level and the second emission signal EM2 may have the deactivation level. For example, the first emission signal EM1 may have the high level and the second emission signal EM2 may have the high level. The initialization gate signal GR may have a deactivation level and the anode initialization gate signal GB may have the activation level. For example, the initialization gate signal GR may have the low level and the anode initialization gate signal GB may have the high level. In addition, the first to m-th writing gate signals GW[1] to GW[m] may sequentially have an activation level. For example, the first to m-th writing gate signals GW[1] to GW[m] may sequentially have the high level. The first to m-th writing gate signals GW[1] to GW[m] may overlap and may have the activation level. For example, the first writing gate signal GW[1] and the second writing gate signal GW[2] may both have the high level for an overlapping interval, such that the activation period of GW[1] partially overlaps with the activation period of GW[2].

As described in FIG. 6, the second transistor T2 may be turned on in response to the n-th writing gate signal GW[n] having the activation level and the third transistor T3 may be turned off in response to the first emission signal EM1 having the deactivation level. The fourth transistor T4 may be turned on in response to the anode initialization gate signal GB having the activation level and the fifth transistor T5 may be turned off in response to the initialization gate signal GR having the deactivation level. In addition, the sixth transistor T6 may be turned off in response to the second emission signal EM2 having the deactivation level.

At a coupling point CT (e.g., a time point), a level of the first emission signal EM1 may change from the activation level to the deactivation level. The voltage of the second node N2 may be changed by a coupling operation of the second capacitor C2.

At the coupling point CT, when the level of the first emission signal EM1 increases from the low level to the high level, the voltage of the second node N2 may be increased by an amount of change of the level of the first emission signal EM1 due to the coupling operation of the second capacitor C2.

When the pixel circuits PX included in each of the first to m-th pixel rows are connected to the same data line DL, the gray-level applied to each pixel circuit PX corresponds to the gray-level of its respective pixel row. For example, the pixel circuit PX of the first pixel row receives the gray-level of the first pixel row. The pixel circuit PX of the second pixel row receives the gray-level of the second pixel row. Likewise, the pixel circuit PX of the m-th pixel row receives the gray-level of the m-th pixel row.

When the second transistor T2 is turned on, the data voltage VDATA may be transmitted to the first node N1. That is, the data voltage VDATA may be transmitted to the control electrode of the first transistor T1. For example, when the first writing gate signal GW[1] has the activation level, the second transistor T2 included in the pixel circuit PX of the first pixel row may be turned on and the data voltage VDATA corresponding to the gray-level of the first pixel row may be transmitted to the control electrode of the first transistor T1 included in the pixel circuit PX of the first pixel row. When the second writing gate signal GW[2] has the activation level, the second transistor T2 included in the pixel circuit PX of the second pixel row may be turned on and the data voltage VDATA corresponding to the gray-level of the second pixel row may be transmitted to the control electrode of the first transistor T1 included in the pixel circuit PX of the second pixel row. In this way, when the m-th writing gate signal GW[m] has the activation level, the second transistor T2 included in the pixel circuit PX of the m-th pixel row may be turned on and the data voltage VDATA corresponding to the gray-level of the m-th pixel row may be transmitted to the control electrode of the first transistor T1 included in the pixel circuit PX of the m-th pixel row.

The fourth period P4 may be referred to as an emission period. In the fourth period P4, the first emission signal EM1 may have the activation level and the second emission signal EM2 may have the activation level. For example, the first emission signal EM1 may have the low level and the second emission signal EM2 may have the low level. The initialization gate signal GR may have the deactivation level and the anode initialization gate signal GB may have a deactivation level. For example, the initialization gate signal GR may have the low level and the anode initialization gate signal GB may have the low level. In addition, the first to m-th writing gate signals GW[1] to GW[m] may have the deactivation level. For example, the first to m-th writing gate signals GW[1] to GW[m] may have the low level.

As described in FIG. 7, the second transistor T2 may be turned off in response to the n-th writing gate signal GW[n] having the deactivation level and the third transistor T3 may be turned on in response to the first emission signal EM1 having the activation level. The fourth transistor T4 may be turned off in response to the anode initialization gate signal GB having the deactivation level and the fifth transistor T5 may be turned off in response to the initialization gate signal GR having the deactivation level. In addition, the sixth transistor T6 may be turned on in response to the second emission signal EM2 having the activation level.

When the level of the first emission signal EM1 decreases from the high level to the low level, the voltage of the second node N2 may be decreased by the amount of change of the level of the first emission signal EM1 due to the coupling operation of the second capacitor C2.

The first transistor T1 may generate a driving current based on the data voltage VDATA. The driving current generated by the first transistor T1 may flow to the third node N3 through the third transistor T3, which is turned on. In addition, the driving current may flow to the light emitting element EE through the sixth transistor T6, which is turned on. The light emitting element EE may emit light based on the driving current.

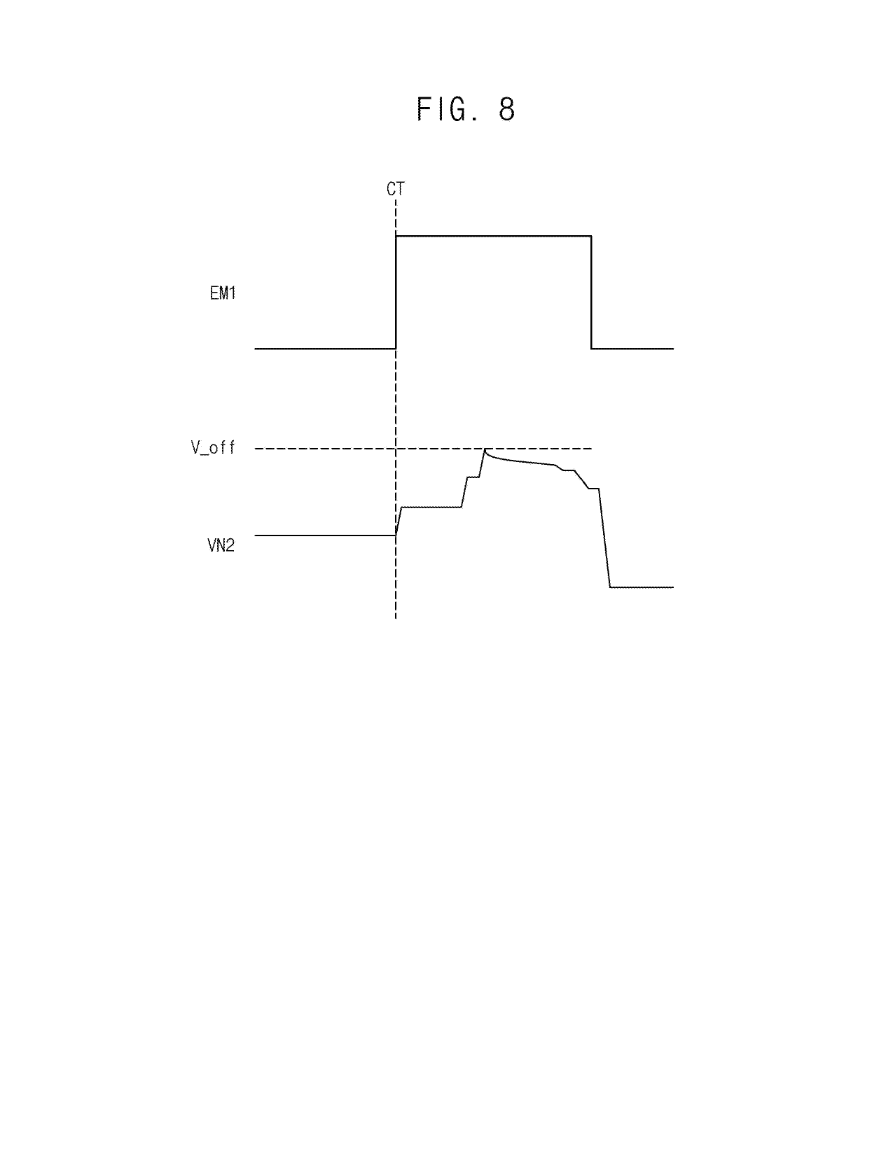

FIG. 8 is a graph illustrating the voltage of the second node N2 included in the pixel circuit PX of FIG. 2 in the third period P3 of the timing diagram of FIG. 3.

Referring to FIG. 8, at the coupling point CT, the level of the first emission signal EM1 may change from the activation level to the deactivation level. For example, at the coupling point CT, the level of the first emission signal EM1 may increase from the low level to the high level. For convenience of explanation, it is assumed that the pixel circuit PX is included in the n-th pixel row. In addition, it is assumed that the pixel circuit PX of the n-th pixel row and the pixel circuit PX of the (n-1)-th pixel row are connected to the same data line DL.

The level of the first emission signal EM1 increases from the low level to the high level at the coupling point CT, so that in the third period P3, the voltage VN2 of the second node N2 may be increased by the amount of change of the level of the first emission signal EM1 due to the coupling operation of the second capacitor C2. For example, in the third period P3, the voltage VN2 of the second node N2 may be increased by a difference between the high level of the first emission signal EM1 and the low level of the first emission signal EM1. In the third period P3, the voltage VN2 of the second node N2 may increase up to an off voltage V_off. The off voltage V_off is a voltage which turns off the first transistor T1 regardless of the voltage of the first node N1.

When the pixel circuit PX of the n-th pixel row and the pixel circuit PX of the (n-1)-th pixel row are connected to the same data line DL, the gray-level applied to the pixel circuit PX included in the (n-1)-th pixel row is the gray-level of the (n-1)-th pixel row and the gray-level applied to the pixel circuit PX of the n-th pixel row is the gray-level of the n-th pixel row.

In the third period P3 for the pixel circuit PX of the n-th pixel row, when the data voltage VDATA corresponds to the gray-level of the (n-1)-th pixel row, the data voltage VDATA may be transmitted to the first node N1. For example, the first node N1 may have the data voltage VDATA corresponding to the gray-level of the (n-1)-th pixel row. When the second node N2 has the off voltage V_off, the difference between the voltage of the first node N1 and the voltage VN2 of the second node N2 may be less than the threshold voltage of the first transistor T1 regardless of the voltage of the first node N1. Accordingly, the first transistor T1 may be turned off regardless of the voltage of the first node N1.

For example, the data voltage VDATA corresponding to the gray-level of the (n-1)-th pixel row may be a maximum gray-level, and this maximum gray-level may be greater than the reference voltage VREF. The data voltage VDATA corresponding to the gray-level of the (n-1)-th pixel row may be transmitted to the first node N1. For example, the data voltage VDATA corresponding to the maximum gray-level may be transmitted to the first node N1. Even if the first node N1 has the data voltage VDATA corresponding to the maximum gray-level, when the second node N2 has an off voltage V_off, the difference between the voltage of the first node N1 and the voltage VN2 of the second node N2 may be less than the threshold voltage of the first transistor T1. Accordingly, the first transistor T1 may be turned off.

For example, the data voltage VDATA corresponding to the gray-level of the (n-1)-th pixel row may be identical to the reference voltage VREF. The data voltage VDATA corresponding to the gray-level of the (n-1)-th pixel row may be transmitted to the first node N1. For example, the data voltage VDATA corresponding to the gray-level of the (n-1)-th pixel row, which is identical to the reference voltage VREF, may be transmitted to the first node N1. Even if the first node N1 has a voltage identical to the reference voltage VREF, when the second node N2 has an off voltage V_off, the difference between the voltage of the first node N1 and the voltage VN2 of the second node N2 may be less than the threshold voltage of the first transistor T1. Accordingly, the first transistor T1 may be turned off.

For example, the data voltage VDATA corresponding to the gray-level of the (n-1)-th pixel row may be a minimum gray-level, and this minimum gray-level may be less than the reference voltage VREF. The data voltage VDATA corresponding to the gray-level of the (n-1)-th pixel row may be transmitted to the first node N1. For example, the data voltage VDATA corresponding to the minimum gray-level may be transmitted to the first node N1. When the first node N1 has the data voltage VDATA corresponding to the minimum gray-level and the second node N2 has an off voltage V_off, the difference between the voltage of the first node N1 and the voltage VN2 of the second node N2 may be less than the threshold voltage of the first transistor T1. Accordingly, the first transistor T1 may be turned off.

In the third period P3 for the pixel circuit PX of the n-th pixel row, according to an embodiment, the first transistor T1 is turned off regardless of the voltage of the first node N1, so that the voltage VN2 of the second node N2 in the third period P3 is not changed according to the voltage of the first node N1. For example, the voltage VN2 of the second node N2 should not be changed according to the data voltage VDATA corresponding to the gray-level of the (n-1)-th pixel row. In addition, in the fourth period P4, when the first emission signal EM1 changes from the high level to the low level, the voltage VN2 of the second node N2 may be decreased by the amount of change of the level of the first emission signal EM1 due to the coupling operation of the second capacitor C2. For example, the voltage VN2 of the second node N2, which is increased by the coupling operation of the second capacitor C2 in the third period P3, may be decreased by the coupling operation of the second capacitor C2 in the fourth period P4.

The voltage VN2 of the second node N2 is decreased by the coupling operation of the second capacitor C2 in the fourth period P4 for the pixel circuit PX of the n-th pixel row, so that the pixel circuit PX of the n-th pixel row may emit light at the target luminance corresponding to the data voltage VDATA corresponding to the gray-level of the n-th pixel row. Accordingly, the display quality of the display device 1 may be enhanced.

In an embodiment, the first transistor T1 is turned off in the third period P3, so that the leakage current flowing through the first transistor T1 may decrease. When the leakage current decreases, power consumption of the display device 1 may be reduced.

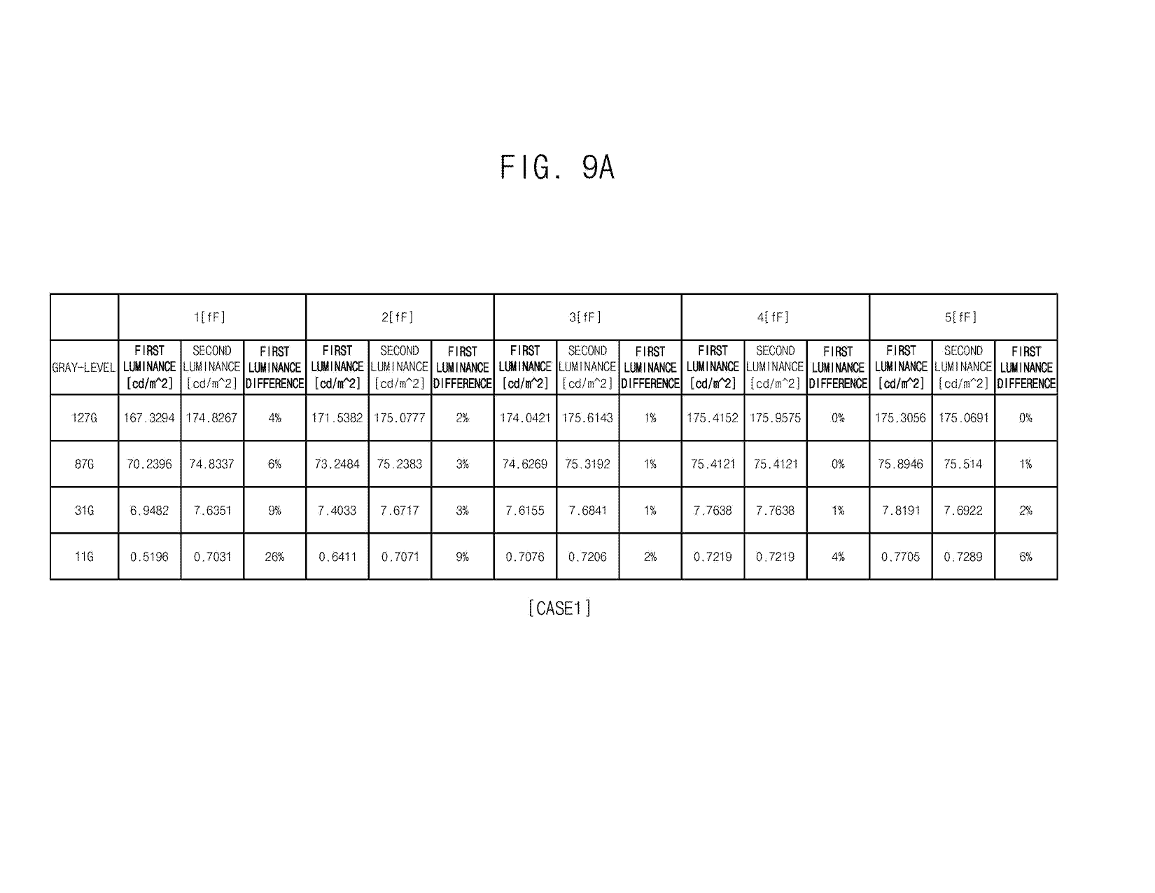

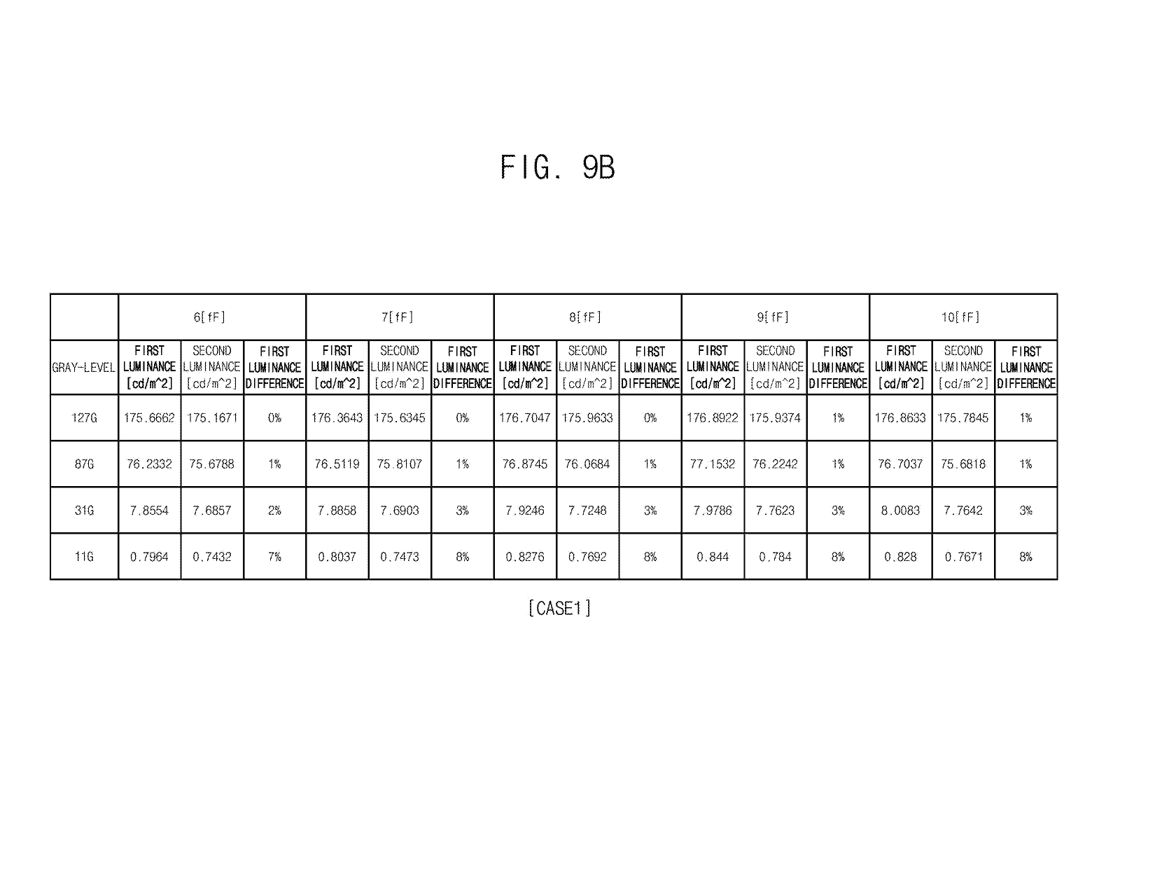

FIGS. 9A and 9B are tables illustrating an embodiment of a luminance difference according to a capacitance of the second capacitor C2 of the pixel circuit PX of FIG. 2 included in the n-th pixel row in a first case CASE1 in which the gray-level of the (n-1)-th pixel row is the maximum gray-level.

Referring to FIGS. 9A and 9B, in the first case CASE1 in which the gray-level of the (n-1)-th pixel row is the maximum gray-level, a first luminance difference may be different according to the gray-level of the n-th pixel row and the capacitance of the second capacitor C2.

When the data voltage VDATA of the (n-1)-th pixel row corresponds to the maximum gray-level and the data voltage VDATA of the n-th pixel row corresponds to the next lower gray-level, a first luminance is a luminance at which the pixel circuit PX of the n-th pixel row emits light.

When the data voltage VDATA of the (n-1)-th pixel row corresponds to the first gray-level and the data voltage VDATA of the n-th pixel row also corresponds to the same first gray-level, a second luminance is a luminance at which the pixel circuit PX of the n-th pixel row emits light. For example, when the data voltage VDATA of the (n-1)-th pixel row and the n-th pixel row are identical, the second luminance is the luminance at which the pixel circuit PX of the n-th pixel row emits light.

For example, gray-levels may be divided into 0 to 255 gray-levels. The 0 gray-level is the minimum gray-level and the 255 gray-level is the maximum gray-level. The minimum gray-level is the gray-level for displaying a black and the maximum gray-level is the gray-level for displaying a white. A first gray-level may be one of the 127 gray-level 127G, the 87 gray-level 87G, the 31 gray-level 31G, and the 11 gray-level 11G.

The first luminance difference may be defined as a ratio of the first luminance to the second luminance. For example, the first luminance difference may be expressed as “Lud1 = ((Lu2 − Lu1) / Lu2) * 100”, where Lud1 denotes the first luminance difference, Lu1 denotes the first luminance, and Lu2 denotes the second luminance.

As described in FIGS. 9A and 9B, the first luminance difference may be different according to the capacitance of the second capacitor C2. As the first luminance difference decreases, the pixel circuit PX of the n-th pixel row may emit light accurately at the target luminance regardless of the gray-level of the (n-1)-th pixel row.

The first luminance difference does not always decrease as the capacitance of the second capacitor C2 increases. When the second capacitor C2 has an appropriate capacitance, the first luminance difference may be minimized. For example, when the capacitance of the second capacitor C2 is 3 fF (e.g., femtofarads), the maximum value of the first luminance difference may be minimized. For example, when the second capacitor C2 has an appropriate capacitance within a suitable range, the display quality of the display device 1 may be enhanced without a significant increase in size of the pixel circuit PX.

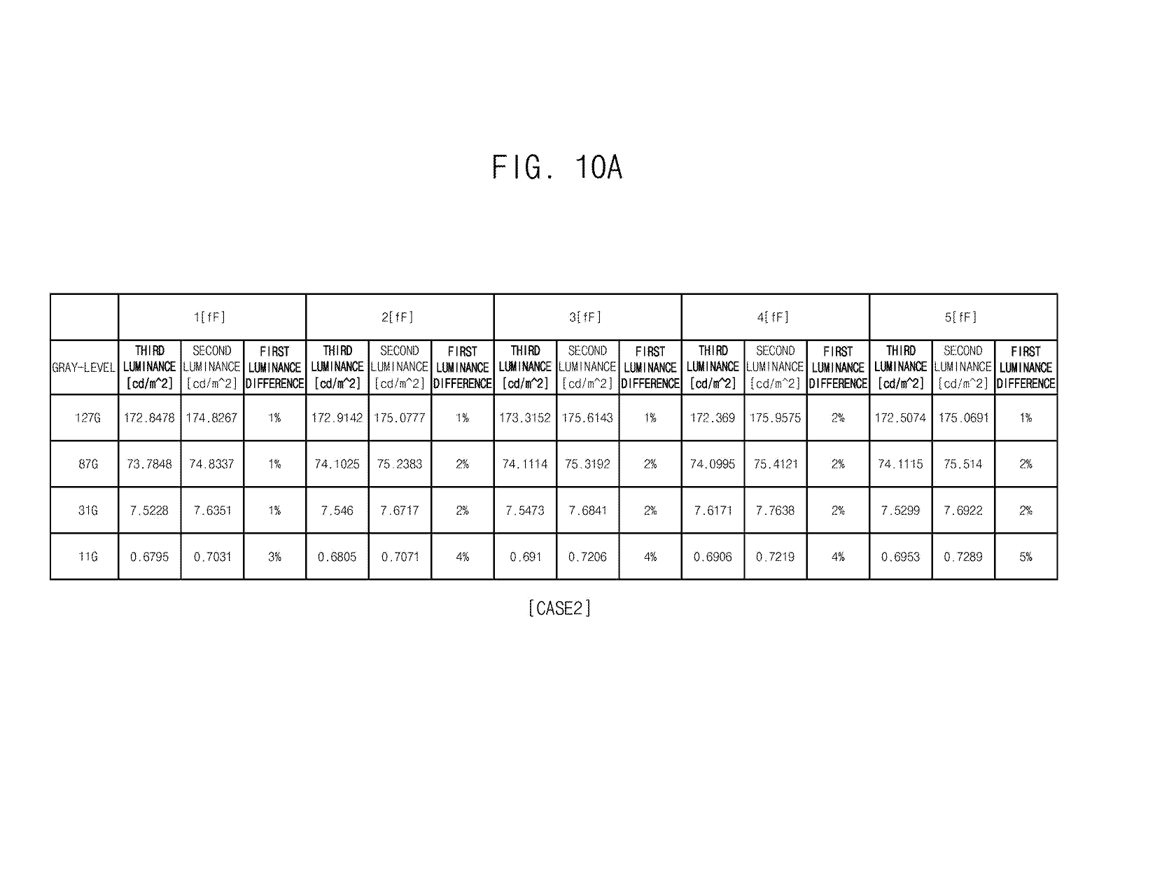

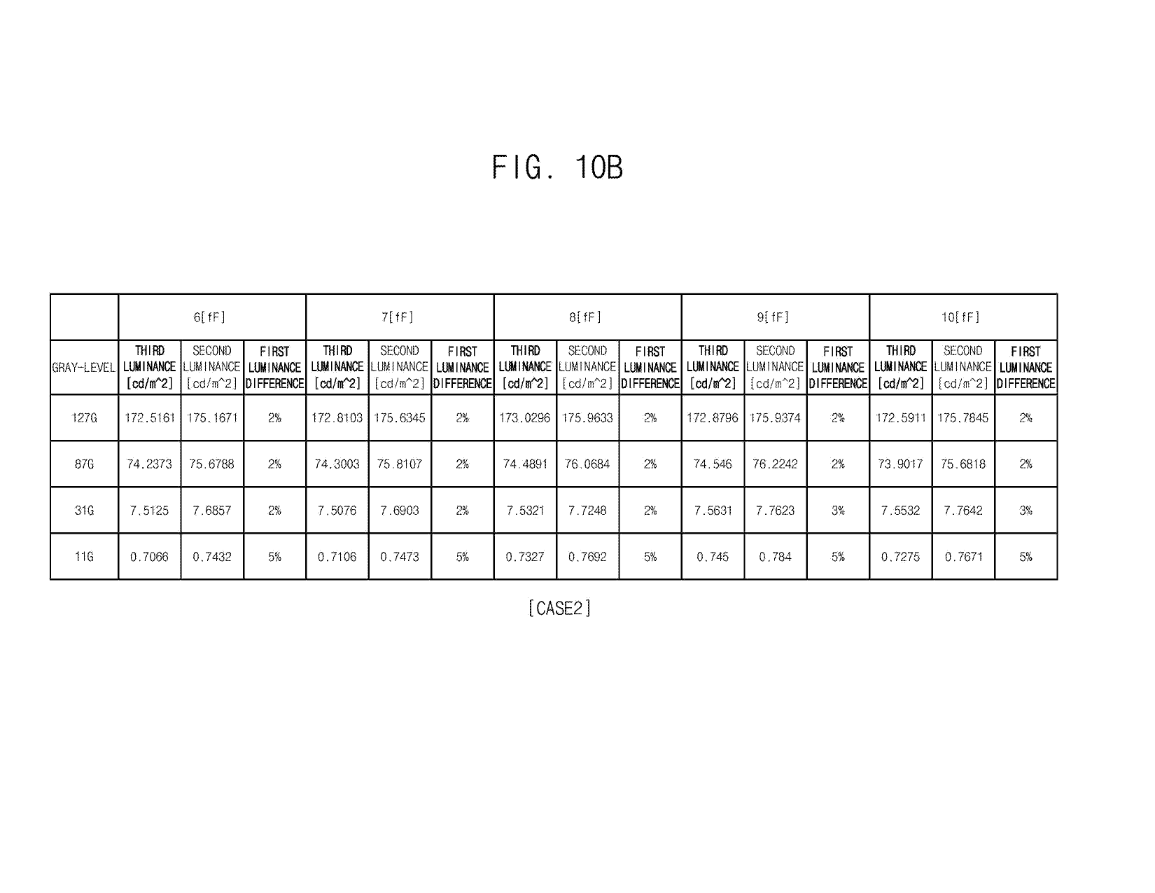

FIGS. 10A and 10B are tables illustrating an embodiment of the luminance difference according to the capacitance of the second capacitor C2 of the pixel circuit PX of FIG. 2 included in the n-th pixel row in a second case CASE2 in which the gray-level of the (n-1)-th pixel row is the minimum gray-level.

Referring to FIGS. 10A and 10B, in the second case CASE2 in which the gray-level of the (n-1)-th pixel row is the minimum gray-level, the second luminance difference may be different according to the gray-level of the n-th pixel row and the capacitance of the second capacitor C2.

When the data voltage VDATA of the (n-1)-th pixel row corresponds to the minimum gray-level and the data voltage VDATA of the n-th pixel row corresponds to the next higher gray-level, a third luminance is a luminance at which the pixel circuit PX of the n-th pixel row emits light.

When the data voltage VDATA of the (n-1)-th pixel row and the data voltage VDATA of the n-th pixel row correspond to the same first gray-level, the second luminance is the luminance at which the pixel circuit PX of the n-th pixel row emits light. For example, when the data voltage VDATA of the (n-1)-th pixel row and the n-th pixel row are identical, the second luminance is the luminance at which the pixel circuit PX of the n-th pixel row emits light.

A second luminance difference may be defined as a ratio of the second luminance to the third luminance. For example, the second luminance difference may be expressed as “Lud2=((Lu2 - Lu3)/Lu2)*100”, where Lud2 denotes the second luminance difference, Lu2 denotes the second luminance, and Lu3 denotes the third luminance.

As described in FIGS. 10A and 10B, the second luminance difference may be different according to the capacitance of the second capacitor C2. When the second luminance difference decreases, the pixel circuit PX of the n-th pixel row may accurately emit light at the target luminance regardless of the gray-level of the (n-1)-th pixel row.

The second luminance difference may not decrease as the capacitance of the second capacitor C2 increases. However, when the second capacitor C2 has an appropriate capacitance, the second luminance difference may be minimized. For example, when the capacitance of the second capacitor C2 is 3 fF, a maximum value of the second luminance difference may be minimized. That is, as the second capacitor C2 has the appropriate capacitance, the display quality of the display device 1 may be enhanced without a significant increase in size of the pixel circuit PX.

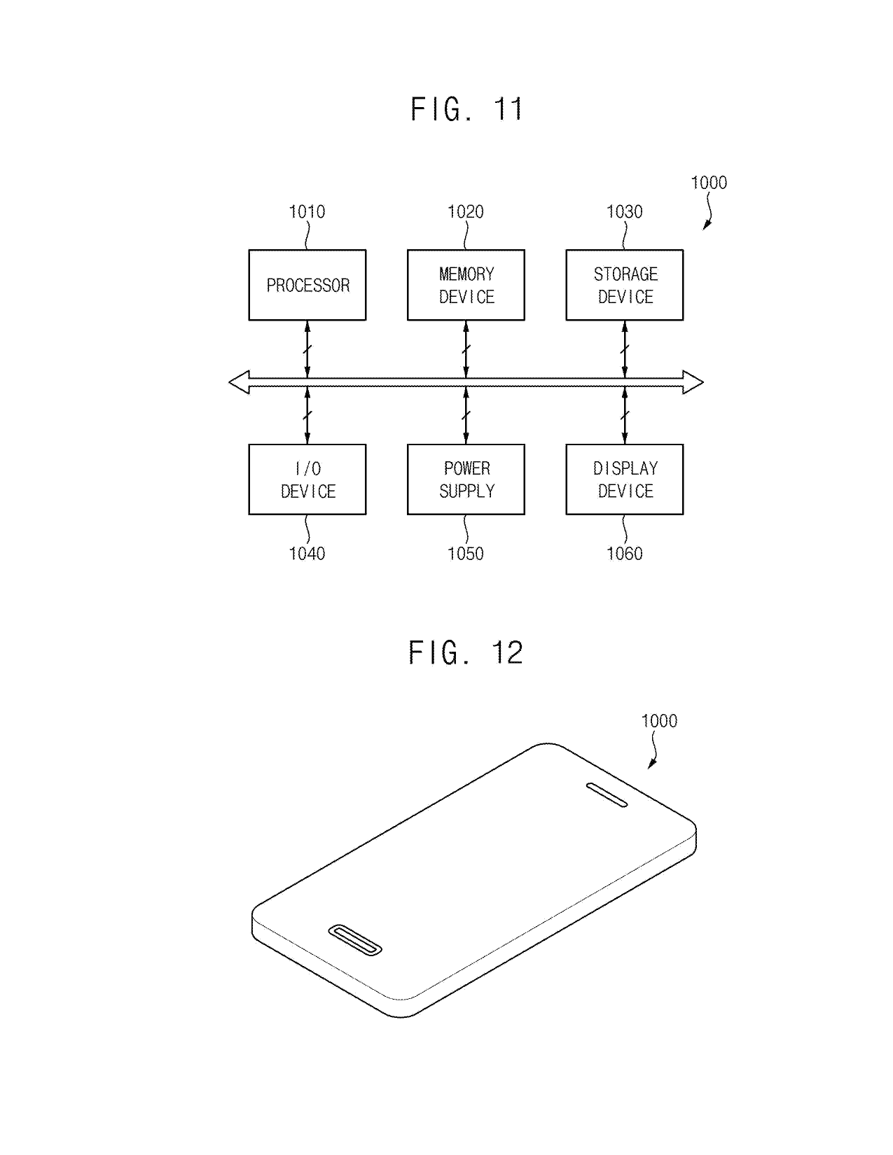

FIG. 11 is a block diagram illustrating an electronic device 1000 according to embodiments of the present inventive concept. FIG. 12 is a diagram illustrating an embodiment in which the electronic device 1000 of FIG. 11 is implemented as a smart phone.

Referring to FIGS. 11 and 12, the electronic device 1000 may include a processor 1010, a memory device 1020, a storage device 1030, an input/output (I/O) device 1040, a power supply 1050, and a display device 1060. In addition, the electronic device 1000 may further include ports for communicating with a video card, a sound card, a memory card, a universal serial bus (USB) device, other electronic device, and the like.

In an embodiment, as illustrated in FIG. 12, the electronic device 1000 may be implemented as the smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions. The processor 1010 may be a micro-processor, a central processing unit (CPU), an application processor (AP), and the like. The processor 1010 may be coupled to other components via an address bus, a control bus, a data bus, and the like. Further, the processor 1010 may be coupled to an extended bus such as a peripheral component interconnection (PCI) bus.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like, and an output device such as a printer, a speaker, and the like. According to an embodiment, the I/O device 1040 may include the display device 1060. The power supply 1050 may provide power for operations of the electronic device 1000.

The display device 1060 may be connected to other components through buses or other communication links.

In an embodiment, the display device 1060 may be the display device 1 of FIG. 1. The display device 1 may include the display panel 100 and the display panel driver 700. The display panel driver 700 may include the driving controller 200.

The processor 1010 may generate the input image data IMG and the input control signal CONT and may output the input image data IMG and the input control signal CONT to the driving controller 200 included in the display device 1.

The display device 1 may include the display panel 100 and the display panel 100 may include the pixel circuit PX of FIG. 2. The pixel circuit PX may include the first transistor T1 including the control electrode connected to the first node N1, the first electrode which receives the first power supply voltage ELVDD, and the second electrode connected to the second node N2, the second transistor T2 including the control electrode which receives the writing gate signal GW, the first electrode which receives the data voltage VDATA, and the second electrode connected to the first node N1, the third transistor T3 including the control electrode which receives the first emission signal EM1, the first electrode connected to the second node N2, and the second electrode connected to the third node N3, the first capacitor C1 including the first electrode connected to the first node N1 and the second electrode connected to the third node N3, the second capacitor C2 including the first electrode connected to the second node N2 and the second electrode which receives the first emission signal EM1, and the light emitting element EE including the anode electrode ANODE and the cathode electrode CATHODE which receives the second power supply voltage ELVSS.

When the pixel circuit PX includes the second capacitor C2, the voltage VN2 of the second node N2 may be increased by the coupling operation of the second capacitor C2 during the data writing period. When the voltage VN2 of the second node N2 is increased in the data writing period, the difference between the voltage of the first node N1 and the voltage VN2 of the second node N2 may be less than the threshold voltage of the first transistor T1 regardless of the voltage of the first node N1. That is, in the data writing period, the first transistor T1 may be turned off regardless of the voltage of the first node N1. When the first transistor T1 is turned off in the data writing period, the voltage VN2 of the second node N2 should not be changed according to the voltage of the first node N1. When the voltage VN2 of the second node N2 is not changed according to the voltage of the first node N1, the pixel circuit PX may emit light at the target luminance corresponding to the data voltage VDATA and the display quality of the display device 1 may be enhanced.

The present inventive concepts may be applied to a display device and an electronic device including the display device. For example, the present inventive concepts may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, etc.

The foregoing is illustrative of the inventive concept and is not to be construed as limiting thereof. Although a few embodiments of the inventive concept have been described, those skilled in the art will readily appreciate that many modifications are possible in the embodiments without materially departing from the inventive concept. Accordingly, all such modifications are intended to be included within the scope of the inventive concept as defined in the claims. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims.

What is claimed is:

1. A pixel circuit comprising:
a first transistor including a control electrode connected to a first node, a first electrode configured to receive a first power supply voltage, and a second electrode connected to a second node;
a second transistor including a control electrode configured to receive a writing gate signal, a first electrode configured to receive a data voltage, and a second electrode connected to the first node;
a third transistor including a control electrode configured to receive a first emission signal, a first electrode connected to the second node, a second electrode connected to a third node;
a first capacitor including a first electrode connected to the first node and a second electrode connected to the third node;
a second capacitor including a first electrode connected to the second node and a second electrode configured to receive the first emission signal; and
a light emitting element connected to receive a second power supply voltage.

2. The pixel circuit of claim 1, wherein the second capacitor is configured to change a voltage of the second node in response to a change in a level of the first emission signal.

3. The pixel circuit of claim 2, wherein the second capacitor is configured to increase a voltage of the second node in response to the level of the first emission signal increasing from a low level to a high level.

4. The pixel circuit of claim 3, wherein the first transistor is configured to turn off when the voltage of the second node is increased to the high level.

5. The pixel circuit of claim 2, wherein the second capacitor is configured to decrease a voltage of the second node in response to the level of the first emission signal decreasing from a high level to a low level.

6. The pixel circuit of claim 1, wherein the pixel circuit further includes a fourth transistor including a control electrode configured to receive an anode initialization gate signal, a first electrode configured to receive an anode initialization voltage, and a second electrode connected to the anode electrode of the light emitting element.

7. The pixel circuit of claim 1, wherein the pixel circuit further includes a fifth transistor including a control electrode configured to receive an initialization gate signal, a first electrode configured to receive a reference voltage, and a second electrode connected to the first node.

8. The pixel circuit of claim 1, wherein the pixel circuit further includes a third capacitor including a first electrode configured to receive the first power supply voltage and a second electrode connected to the third node.

9. The pixel circuit of claim 8, wherein the first transistor further includes a second control electrode connected to the third node.

10. The pixel circuit of claim 1, wherein the pixel circuit further includes a sixth transistor including a control electrode configured to receive a second emission signal, a first electrode connected to the third node, and a second electrode connected to the anode electrode of the light emitting element.

11. A display device comprising:
a display panel including a pixel circuit; and
a display panel driver configured to drive the display panel,
wherein the pixel circuit includes:
a first transistor including a control electrode connected to a first node, a first electrode configured to receive a first power supply voltage, and a second electrode connected to a second node;
a second transistor including a control electrode configured to receive a writing gate signal, a first electrode configured to receive a data voltage, and a second electrode connected to the first node;
a third transistor including a control electrode configured to receive a first emission signal, a first electrode connected to the second node, a second electrode connected to a third node;
a first capacitor including a first electrode connected to the first node and a second electrode connected to the third node;
a second capacitor including a first electrode connected to the second node and a second electrode configured to receive the first emission signal; and
a light emitting element connected to receive a second power supply voltage.

12. The display device of claim 11, wherein the second capacitor is configured to change a voltage of the second node in response to a change in a level of the first emission signal.

13. The display device of claim 12, wherein the second capacitor is configured to increase a voltage of the second node in response to the level of the first emission signal increasing from a low level to a high level.

14. The display device of claim 13, wherein the first transistor is configured to turn off when the voltage of the second node is increased to the high level.

15. The display device of claim 12, wherein the second capacitor is configured to decrease a voltage of the second node in response to the level of the first emission signal decreasing from a high level to a low level.

16. An electronic device comprising:
a processor configured to generate an input control signal and input image data;
a display panel including a pixel circuit; and
a display panel driver configured to drive the display panel based on the input control signal and the input image data,
wherein the pixel circuit includes:
a first transistor including a control electrode connected to a first node, a first electrode configured to receive a first power supply voltage, and a second electrode connected to a second node;
a second transistor including a control electrode configured to receive a writing gate signal, a first electrode configured to receive a data voltage, and a second electrode connected to the first node;
a third transistor including a control electrode configured to receive a first emission signal, a first electrode connected to the second node, a second electrode connected to a third node;
a first capacitor including a first electrode connected to the first node and a second electrode connected to the third node;
a second capacitor including a first electrode configured to the second node and a second electrode connected to receive the first emission signal; and
a light emitting element connected to receive a second power supply voltage.

17. The electronic device of claim 16, wherein the second capacitor is configured to change a voltage of the second node in response to a change in a level of the first emission signal.

18. The electronic device of claim 17, wherein the second capacitor is configured to increase a voltage of the second node in response to the level of the first emission signal increasing from a low level to a high level.

19. The electronic device of claim 18, wherein the first transistor is configured to turn off when the voltage of the second node is increased to the high level.

20. The electronic device of claim 17, wherein the second capacitor is configured to decrease a voltage of the second node in response to the level of the first emission signal decreasing from a high level to a low level.
